(19) United States
(12) Patent Application Publication
(10) Pub. No.: US 2011/0063443 A1
(43) Pub. Date: Mar. 17, 2011

(54) CRUISING SURVEILLANCE SYSTEM FOR AUTO DETECTING AND TRACING SUSPECTED INVADERS

(75) Inventor: Chih-Hsiung Yang, Kaohsiung City (TW)

(73) Assignee: NATIONAL KAOHSIUNG UNIVERSITY OF APPLIED SCIENCES, Kaohsiung City (TW)

(21) Appl. No.: 12/868,138

(22) Filed: Aug. 25, 2010

(30) Foreign Application Priority Data
Sep. 16, 2009 (TW) 098131142

(51) Int. Cl. H04N 7/18

(52) U.S. Cl. 348/148; 348/E07.085

(57) ABSTRACT

A cruising surveillance system comprises a plurality of wireless beacons and an unmanned vehicle. Each of the wireless beacons emits a unique wireless sequential signal. The unmanned vehicle is equipped with an infrared object sensor, a video camera recorder, a wireless transceiving unit, a central processing unit, a driving unit, and a power supply unit. The central processing unit compares the wireless sequential signal received from the wireless transceiving unit, and makes the driving unit to move the unmanned vehicle to cruises along a route defined by the wireless beacons. When the object sensor detected a suspected object, the central processing makes the driving unit to move the unmanned vehicle to approach thereto, and makes the video camera recorder to record the suspected object, and transmits a video recording of the suspected object to a surveillance center via the wireless transceiving unit.

### CROSS-REFERENCE TO RELATED APPLICATION

This application claims priority of Taiwan Patent Application No. 098131142, filed on Sep. 16, 2009, entitled “Cruising Surveillance System For Auto Detecting And Tracing Suspected Invaders” by Chin-Hsiung YANG, the disclosure of which is incorporated herein by reference in its entirety.

### FIELD OF THE INVENTION

The invention relates to cruising surveillance system, more particularly to a cruising surveillance system comprising an unmanned vehicle equipped with an infrared object sensor, can cruise along a route defined by a plurality of wireless beacons for tracing suspected objects nearby while in cruising, and transmit video recordings of the suspected objects to a surveillance center.

### BACKGROUND OF THE PRESENT INVENTION

Traditional guarding system includes an alarm reed switches or infrared sensors installed on the windows or doors for detecting thief or invader, and emitting an alarm signal. However, for a wide and open space in an exhibition building or square, it is impossible to install enough amounts of reed switches, infrared sensors or IP cameras at every important corner; in this situation, the thief or invader is easy to sneak into and walk off with important business secret.

When a thief or invader is sneaked inside, there may be no cameras can catch the image or video and stop them from further action timely. To add more guards to patrol around would extremely increase the cost of the guarding system.

Therefore, a heretofore unaddressed need exists in the art to address the aforementioned deficiencies and inadequacies.

### SUMMARY OF THE INVENTION

An object of the present invention is to provide a cruising surveillance system for auto detecting and tracing suspected invaders when cruising along an easy change route defined by a plurality of sequential wireless beacons, and traces any detected suspected object nearby and transmits the video to a surveillance center.

According to the present invention, the cruising surveillance system may comprise a plurality of wireless beacons and an unmanned vehicle. Each of the wireless beacons emits a unique wireless sequential signal for defining a route. The unmanned vehicle is equipped with an infrared object sensor, a video camera recorder, a wireless transceiving unit, a central processing unit and a driving unit. The central processing unit compares the wireless sequential signal received from the wireless transceiving unit, and makes the driving unit to move the unmanned vehicle to cruises along the route defined by the wireless beacons. When the infrared object sensor detected a suspected object, the central processing makes the driving unit to move the unmanned vehicle to approach thereto, and makes the video camera recorder to record the detected suspected object, and transmits the video to a surveillance center via the wireless transceiving unit.

### BRIEF DESCRIPTION OF THE DRAWINGS

Further features and benefits of the present invention will be apparent from a detailed description of preferred embodiments thereof taken in conjunction with the following drawings, and wherein:

FIG. 1 schematically illustrates a cruising surveillance system according to one embodiment of the present invention;

FIG. 2 is a flowchart of the cruising surveillance system according to one embodiment of the present invention;

FIG. 3 schematically illustrates the wireless beacons guiding an unmanned vehicle of the cruising surveillance system in an unregulated space with obstacles according to one embodiment of the present invention.

### DETAILED DESCRIPTION OF THE PREFERRED EMBODIMENT

Prior to a detailed description of the present invention(s), the following definitions are provided as an aid to understanding the subject matter and terminology of aspects of the present invention(s), and not necessarily limiting of the present invention(s), which are expressed in the claims. Whether or not a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. A capitalized term within the glossary usually indicates that the capitalized term has a separate definition within the glossary. However, the capitalization or lack thereof within the remainder of this document is not intended to be necessarily limiting unless the context clearly indicates that such limitation is intended.

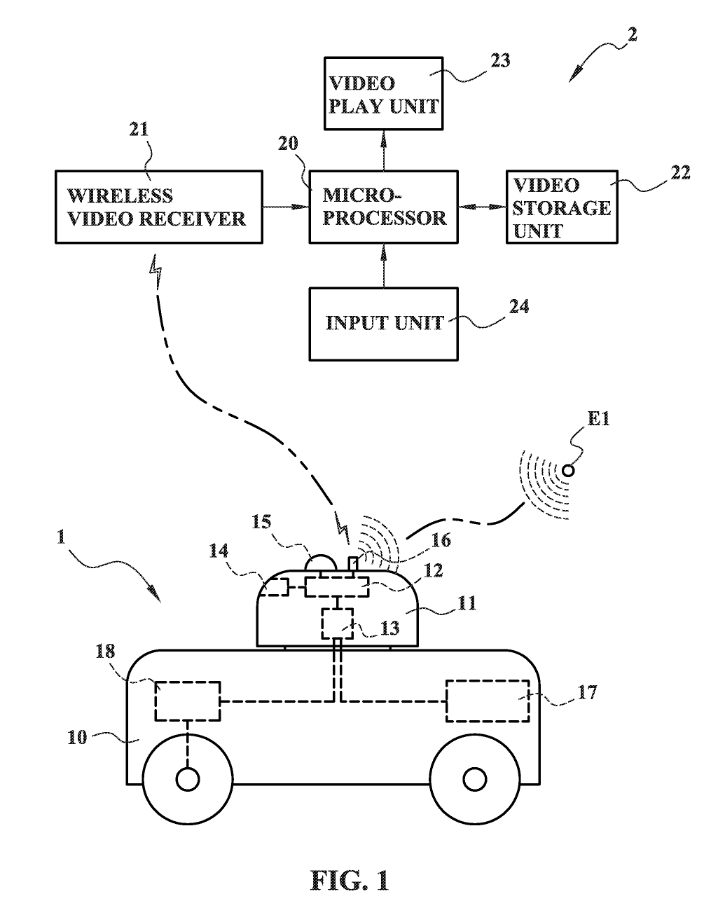

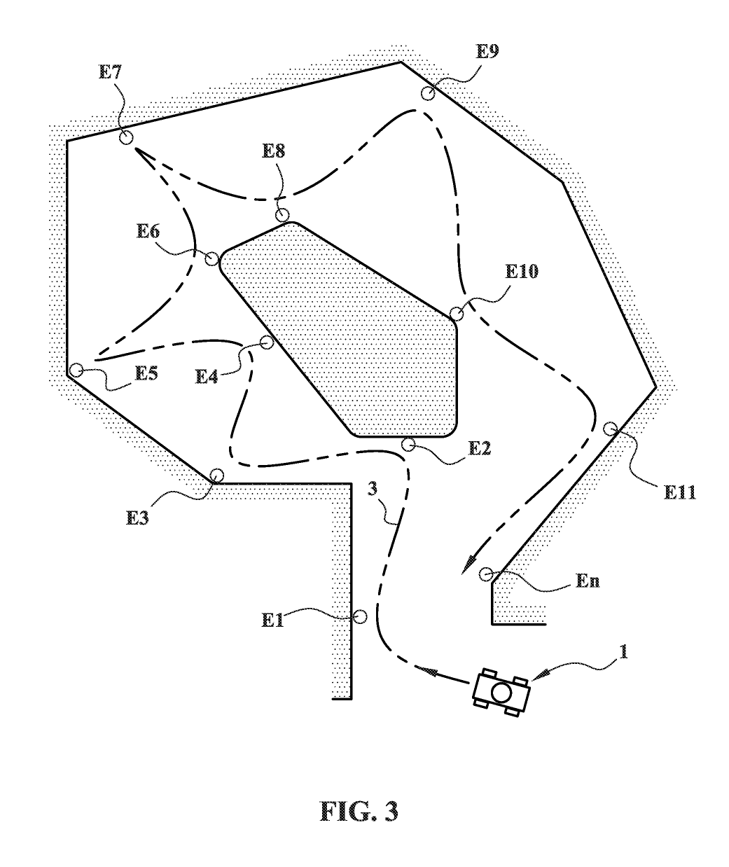

The description will be made as to the embodiments of the present invention in conjunction with the reference to the accompanying drawings in FIGS. 1-3. In accordance with the purposes of this invention, as embodied and broadly described herein, this invention, in one aspect, relates to a cruising surveillance system for auto detecting and tracing suspected invaders.

Referring to FIGS. 1 to 3, the embodiment of cruising surveillance system for auto detecting and tracing suspected invaders, includes: (i) a plurality of wireless beacons E1, E2, E3, . . . En, and (ii) an unmanned vehicle 1.

Each of the wireless beacons E1, E2, E3, . . . En emits a unique wireless sequential signal for defining a route 3. The route 3 is disposed and changeable by reposition the wireless beacons E1, E2, E3, . . . En.

The unmanned vehicle 1 is equipped with vehicle frame 10, a swivel mount 11, a central processing unit 12, a driving motor 13, a video camera recorder 14, an infrared object sensor 15, a wireless transceiving unit 16, a power supply unit 17 and a driving unit 18.

The vehicle frame 10 is driven by the driving unit 18 for carrying the central processing unit 12, the video camera recorder 14, the infrared object sensor 15, the wireless transceiving unit 16, and the unmanned vehicle 1 cruises along the route 3.

The central processing unit 12 is coupled with the video camera recorder 14, the infrared object sensor 15, the wireless transceiving unit 16, the power supply unit 17 and the driving unit 18. The central processing unit 12 compares the wireless sequential signal received from the wireless transceiving unit 16, and makes the driving unit 18 to move the unmanned vehicle 1 and approach a nearest wireless beacon, and then move the unmanned vehicle 1 toward next sequential wireless beacon. By this way, guiding the unmanned vehicle 1 to cruises along the route 3 defined by the wireless beacons E1, E2, E3, . . . En.

When a suspected object is detected, the central processing unit 12 makes the driving unit 18 to drive the vehicle frame 10 toward the detected suspected object. In the meantime, makes the driving motor 13 to rotate the swivel mount 11 to aim the video camera recorder 14 at the detected suspected object, and then transmits the video taken by the video camera recorder 14 to the surveillance center 2.

In one embodiment, the surveillance center 2 includes a microprocessor 20 which is coupled with a wireless video receiver 21, a video storage unit 22, a video play unit 23 and an input unit 24. The guards in the surveillance center 2 can watch the image or video received from a plurality of unmanned vehicles 1 that are cruising on different routes 3 at same time, through the video play unit 23. The images and/or videos received from the plurality of unmanned vehicles 1 are saved the in the video storage unit 22.

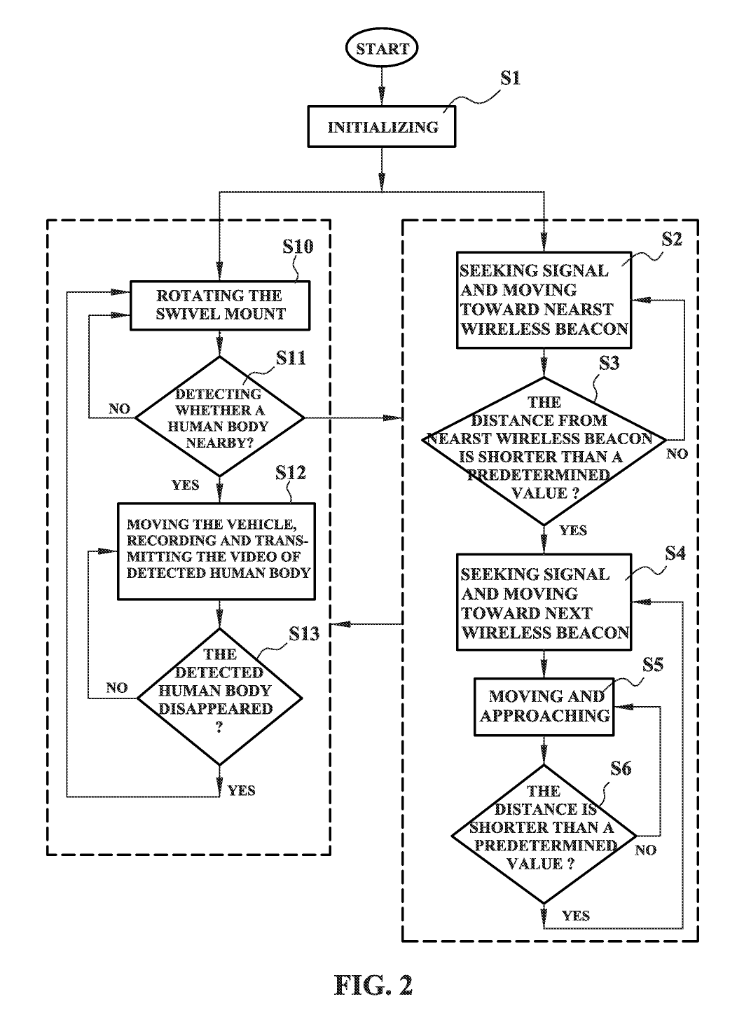

Referring now to FIG. 2, a flowchart of the cruising surveillance system is shown according to one embodiment of the present invention. At the start, the central processing unit 12 proceeds the steps of:
a. initializing (S1);
b. seeking the wireless sequential signal from the wireless beacons E1, E2, E3, . . . En, and making the driving unit 18 to move the unmanned vehicles 1 toward the nearest wireless beacon (S2);
c. calculating whether the distance from said wireless beacon is shorter than a predetermined value? (S3)

When the distance is shorter than the predetermined value (for example shorter than 0.5 meter), the central processing unit 12 proceeds the step of:
d. seeking and moving the unmanned vehicles 1 toward the wireless beacons which emits next wireless sequential signal (S4) and
e. moving thereto (S5).

Again, when the distance is shorter than the predetermined value, repeat the step of (S4) to (S6) so as to cruise along the route 3.

In the meantime, the central processing unit 12 proceeds the steps of:
f. controlling the driving motor 13 to rotate the swivel mount 11 (S10),
g. detecting via the infrared object sensor 15 to determine whether a suspected object is nearby? (S11);
h. if a suspected object is detected, moving the unmanned vehicle 1 toward the suspected object and transmitting the image or video to the surveillance center 2 as being described (S12) until the detected suspected object disappears from the sensible range of the (S13).

When the detected suspected object disappears from the sensible range of the infrared object sensor 15, the central processing unit 12 proceeds the step of:
i. seeking the wireless sequential signal from the wireless beacons E1, E2, E3, . . . En; and controlling the driving unit 18 to move the unmanned vehicles 1 toward a nearest wireless beacon (S2). By this way, the unmanned vehicle 1 is returning back to the route 3.

In one embodiment, the surveillance center 2 can be embodied as a desktop, laptop, or notebook personal computer which is communicatively connected to the wireless video receiver 21. The CPU of the personal computer performs the functions of the microprocessor 20, the hard disk of the personal computer may be utilized as the video storage unit 22, and the key board of the personal computer may be used as the input unit 24.

In one embodiment, the power supply unit 17 includes a battery that supplies electrical power to the central processing unit 12, the driving unit 18, the driving motor 13, the wireless transceiving unit 16 and the infrared object sensor 15.

Comparing to traditional unmanned surveillance vehicles, the Cruising Surveillance System For Auto Detecting And Tracing Suspected Invaders of the present invention have the following advantages:
(1). the configuration of the route 3 is easy to dispose and to be changed by arranging or rearranging the wireless beacons E1, E2, E3, . . . En;
(2). the wireless beacons E1, E2, E3, . . . En can be camouflaged, for example, a small sticker of RFID, to void unwanted attention from an invader and to prevent the invader from removing these wireless beacons before the Cruising Surveillance System perform its function; and
(3). as the central processing unit 12 compares only the distance and the sequence of the wireless beacons E1, E2, E3, . . . En to determine the moving direction of the unmanned vehicle 1, even though some of the wireless beacons is lost, the route 3 shall not be broken.

While there has been shown several and alternate embodiments of the present invention, it is to be understood that certain changes can be made as would be known to one skilled in the art without departing from the underlying scope of the present invention as is discussed and set forth above and below including claims. Furthermore, the embodiments described above and claims set forth below are only intended to illustrate the principles of the present invention and are not intended to limit the scope of the present invention to the disclosed elements.

What is claimed is:

1. A cruising surveillance system, comprising:
a plurality of wireless beacons each emitting a unique wireless sequential signal for defining a route;
an unmanned vehicle for cruising along the route, having an infrared object sensor for sensing and detecting a suspected object nearby, and a wireless transceiving unit for transmitting video recordings of the suspected object to a surveillance center.

2. The cruising surveillance system as claimed in claim 1, wherein the unmanned vehicle is equipped with a video camera recorder for recording the suspected object, and while the suspected object is disappeared from a sensible range of the infrared object sensor, the unmanned vehicle is approaching a nearest wireless beacons to return to the route.

3. The cruising surveillance system as claimed in claim 2, wherein the unmanned vehicle is equipped with a central processing unit coupled with the wireless transceiving unit and the video camera recorder, for processing and transmitting the video to the surveillance center.

4. The cruising surveillance system as claimed in claim 3, wherein the central processing unit compares the wireless sequential signals from the wireless beacons to move the unmanned vehicle toward the wireless beacons emitting next sequential signal.

5. The cruising surveillance system as claimed in claim 2, wherein the unmanned vehicle is equipped with a swivel mount for connecting the video camera recorder, and when the infrared object sensor detected a suspected object nearby, the swivel mount rotates and keeps the video camera recorder aimed at the suspected object.

6. The cruising surveillance system as claimed in claim 5, wherein the unmanned vehicle is equipped with a driving motor for rotating the swivel mount.

7. The cruising surveillance system as claimed in claim 1, wherein the unmanned vehicle comprises:
a vehicle frame, having a driving unit for driving the unmanned vehicle;
a swivel mount, having a driving motor for rotating the swivel mount;
a video camera recorder, mounted on the swivel mount;
a central processing unit coupled with the driving unit, the driving motor, the wireless transceiving unit and the infrared object sensor; and
a power supply unit for supplying power to the central processing unit, the driving unit, the driving motor, the wireless transceiving unit and the infrared object sensor.
